(19) United States
(12) Patent Application Publication
(10) Pub. No.: US 2015/0235283 A1
(43) Pub. Date: Aug. 20, 2015

(54) COMMODITY SALES DATA PROCESSING APPARATUS AND COMPUTER PROGRAM

(71) Applicant: TOSHIBA TEC KABUSHIKI KAISHA, Tokyo (JP)

(72) Inventor: Hiroshi Nishikawa, Shizuoka (JP)

(21) Appl. No.: 14/621,637

(22) Filed: Feb. 13, 2015

(30) Foreign Application Priority Data
Feb. 19, 2014 (JP) 2014-029455

(51) Int. Cl. G06Q 30/06

(52) U.S. Cl. CPC G06Q 30/0601

(57) ABSTRACT

According to one embodiment, a commodity sales data processing apparatus includes a key for declaring execution of processing for causing, in a commodity transaction, a customer to make a motion for substantially directly facing an image pickup unit provided in a predetermined position, a customer-image pickup unit configured to pick up, according to operation of the key, using the image pickup unit, a face image of the customer substantially directly facing the image pickup unit, an age-group determining unit configured to compare the picked-up face image and face image data indicating features by age group stored in advance and determine an age group of the customer, and an associating unit configured to associate, according to the operation of the key, the determined age group with commodity information of a commodity traded in the commodity transaction.

### CROSS-REFERENCE TO RELATED APPLICATION

This application is based upon and claims the benefit of priority from Japanese Patent Application No. 2014-029455, filed Feb. 19, 2014, the entire contents of which are incorporated herein by reference.

### FIELD

Embodiments described herein relate generally to a commodity sales data processing apparatus and a computer program.

### BACKGROUND

When determining an age group of a customer purchasing a commodity in a store such as a supermarket, a convenience store, or the like, a store clerk estimates an age group of the customer purchasing the commodity from the personal appearance or the like of the customer and operates a closing key corresponding to the estimated age group of the customer among closing keys provided for respective age groups to determine the age group of the customer.

However, since an age group of the customer to be estimated varies depending on a store clerk, an accurate age group cannot be estimated.

A problem to be solved by the invention is to provide a commodity sales data processing apparatus and a computer program that can determine an accurate age group of a customer.

### DESCRIPTION OF THE DRAWINGS

FIG. 1 is a top plan schematic view of a state in which a POS terminal in an embodiment is set in a store;

FIG. 2 is a perspective view showing an external appearance of the POS terminal viewed from a store clerk side;

FIG. 3 is a perspective view showing an external appearance of the POS terminal viewed from a customer side;

FIG. 4 is a block diagram showing a hardware configuration of the POS terminal;

FIG. 5 is a memory map showing an example of a face master of the POS terminal;

FIG. 6 is a memory map showing an example of an image-pickup time section of the POS terminal;

FIG. 7 is a functional block diagram showing a functional configuration of the POS terminal;

FIG. 8 is a flowchart for explaining a flow of control processing of the POS terminal;

FIG. 9 is a flowchart for explaining a flow of face data processing of the POS terminal;

FIG. 10 is a flowchart for explaining a flow of sex and age group determination processing of the POS terminal; and

FIG. 11 is a diagram schematically showing a part of a memory unit of the POS terminal.

### DETAILED DESCRIPTION

In general, according to one embodiment, a commodity sales data processing apparatus includes: a key for declaring execution of processing for causing, in a commodity transaction, a customer to make a motion for substantially directly facing an image pickup unit provided in a predetermined position; a customer-image pickup unit configured to pick up, according to operation of the key, using the image pickup unit, a face image of the customer substantially directly facing the image pickup unit; an age-group determining unit configured to compare the picked-up face image and face image data indicating features by age group stored in advance and determine an age group of the customer; and an associating unit configured to associate, according to the operation of the key, the determined age group with commodity information of a commodity traded in the commodity transaction.

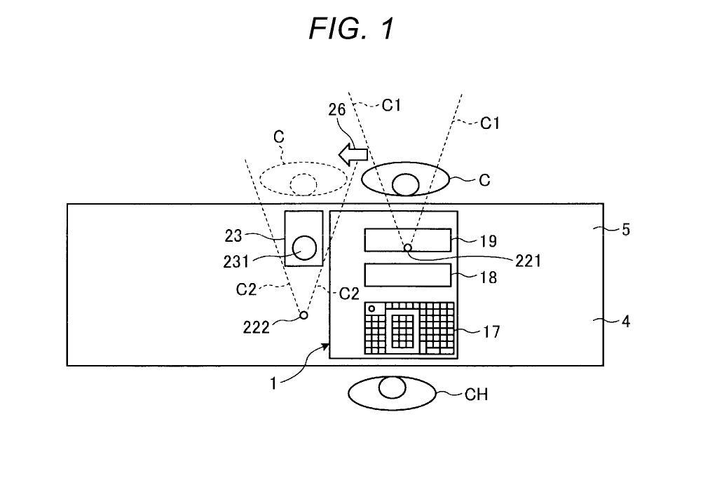

A commodity sales data processing apparatus and a computer program according to an embodiment are explained below with reference to FIGS. 1 to 11. In the embodiment, a POS (Point of Sales) terminal is explained as the commodity sales data processing apparatus. Note that the invention is not limited by the embodiment explained below.

FIG. 1 is a plan schematic view showing a state in which the POS terminal in the embodiment is set in a store. In a store, a checkout counter for settlement of commodities displayed in the store is provided. In FIG. 1, one of a plurality of elongated counters 4 in the checkout counter is shown. A flat plane 5 is formed on the upper surface of the counter 4. A POS terminal 1 is set on the plane 5. An electronic money reader writer 23 that reads and writes electronic money information is set on the plane 5.

When a commodity transaction related to sales of commodities sold in the store is performed and a store clerk CH, who is an operator, or a customer C operates the POS terminal 1, the POS terminal 1 executes commodity registration processing and settlement processing for sold commodities. The commodity registration processing means storing sold commodities in a memory of the POS terminal 1 in order to collectively register the commodities in the memory of the POS terminal 1 or a memory of a store server (not shown in the figure) of the POS terminal 1. The settlement processing means display of a total amount related to the sales of commodities, processing concerning exchange of money, processing for display and an instruction for payment of change, processing for issuing a receipt, and the like.

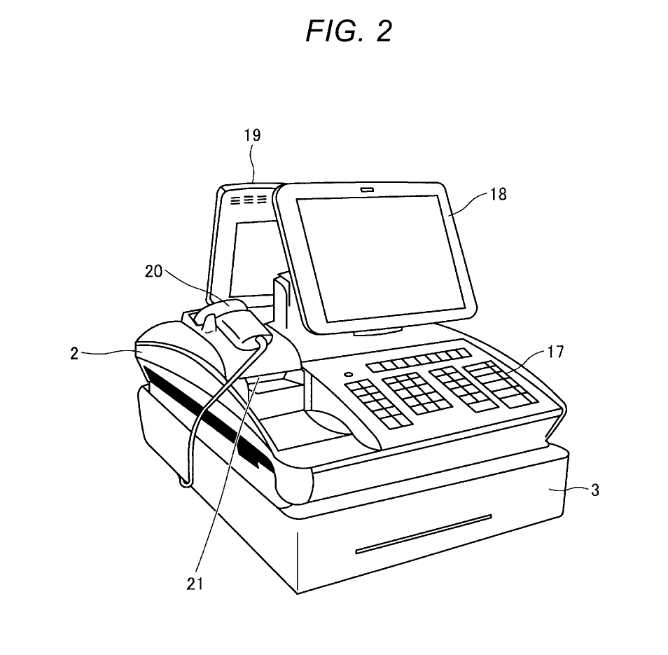

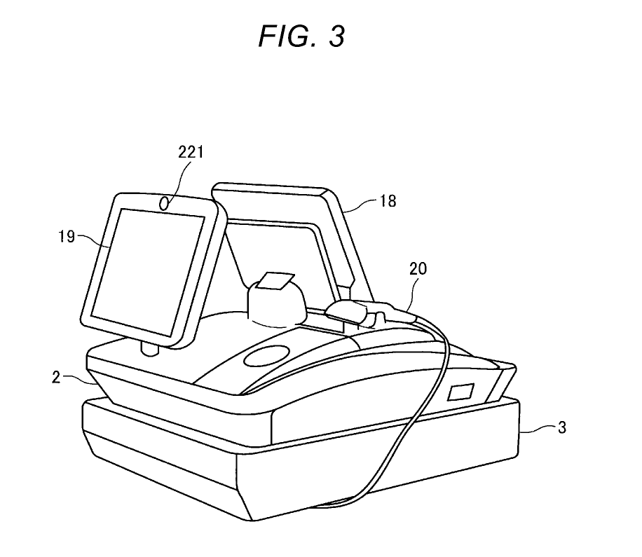

As explained in detail with reference to FIGS. 2 and 3, the POS terminal 1 includes an operation unit 17 such as a keyboard operated by the store clerk CH, a store clerk display unit 18 that displays information to the store clerk CH, and a customer display unit 19 that displays information to the customer C. The store clerk CH operates the POS terminal 1 on an operator side of the counter 4. The customer C stands on the customer C side of the counter 4.

The electronic money reader writer 23 is electrically connected to the POS terminal 1. The electronic money reader writer 23 reads electronic money information stored in an electronic money card placed on or brought close to an upper surface unit 231 and writes electronic money information in the electronic money card. The electronic money reader writer 23 is a multi reader writer adapted to an NFC (Near Field Communication) standard. When the customer C who makes payment using electronic money places an electronic money card carried by the customer C on or brings the electronic money card close to the electronic money reader writer 23, the customer C can make payment by the electronic money stored in the electronic money card.

An image pickup unit A 221 configured by a camera or the like is provided in an outer frame upper part of the customer display unit 19. The image pickup unit A 221 is configured by a CCD (Charge Coupled Device) image sensor or the like. The image pickup unit A 221 is set to face the customer C side. The image pickup unit A 221 is provided in a position substantially directly facing the customer C present in an area surrounded by C1 on the customer C side of the POS terminal 1 when the customer C makes a motion for viewing display on the customer display unit 19. “Substantially directly facing” means that the image pickup unit A 221 and the customer face each other substantially right in front of each other.

An image pickup unit B 222 configured by a camera or the like is provided on the plane 5 of the counter 4 near the electronic money reader writer 23. The image pickup unit B 222 is configured by a CCD or the like. The image pickup unit B 222 is fixed to or embedded in the counter 4. The image pickup unit B 222 is set to face the customer C side. The image pickup unit B 222 moves in an arrow 26 direction from the area of C1 and picks up an image of the customer C in an area surrounded by C2.

The customer C places the electronic money card on or brings the electronic money card close to the upper surface unit 231 of the electronic money reader writer 23 while viewing the upper surface unit 231. The image pickup unit B 222 is provided in a position substantially directly facing the customer C who makes this motion. When the customer C makes the motion for placing the electronic money card on or bringing the electronic money card close to the upper surface unit 231 of the electronic money reader writer 23, the image pickup unit B 222 picks up an image of the customer C substantially directly facing the image pickup unit B 222.

FIG. 2 is a perspective view showing the external appearance of the POS terminal 1 in the embodiment viewed from the store clerk side. In FIG. 2, the POS terminal 1 includes a main body 2 and a money storage box 3. The money storage box 3 includes a drawer and stores money such as bills and coils and marketable securities such as gift certificates deposited by the customer C and change and the like to be paid to the customer C.

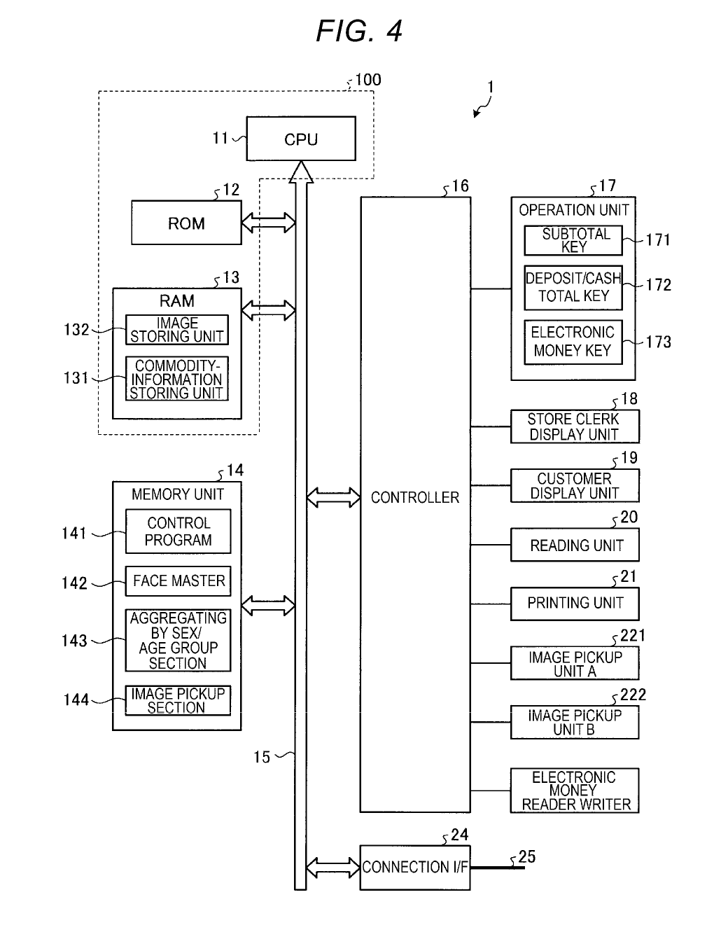

The main body 2 is configured by the operation unit 17 such as a key board, a liquid crystal display, and the like and configured by the store clerk display unit 18 that displays information to an operator, a liquid crystal display, and the like. The customer display unit 19 that displays information to the customer C is set in the main body 2. Further, the main body 2 includes a reading unit 20 that reads codes such as barcodes and two-dimensional codes attached to commodities. The reading unit 20 reads, with a CCD line sensor or the like, the barcodes and the two-dimensional codes attached to the commodities and inputs the barcodes and the two-dimensional codes. The main body 2 includes, on the inside, a control unit (see FIG. 4) of the POS terminal 1 and a printing unit 21 that prints commodity information and issues a receipt.

FIG. 3 is a perspective view showing the external appearance of the POS terminal 1 in the embodiment viewed from the customer C side. In FIG. 3, the main body 2 of the POS terminal 1 includes the store clerk display unit 18, the customer display unit 19, and the reading unit 20. The image pickup unit A 221 configured by the CCD image sensor or the like is provided in an upper part on a display surface side of the customer display unit 19. The image pickup unit A 221 mainly picks up an image of the face of the customer C substantially directly facing the image pickup unit A 221 on the customer C side of the POS terminal 1 (see FIG. 4).

Hardware of the POS terminal 1 is explained with reference to FIGS. 4 to 6. FIG. 4 is a block diagram showing a hardware configuration of the POS terminal 1. In FIG. 4, the POS terminal 1 includes a CPU (Central Processing Unit) 11 functioning as a control entity, a ROM (Read Only Memory) 12 that stores various computer programs, a RAM (Random Access Memory) 13 in which various data are expanded, and a memory unit 14 that stores various computer programs. The CPU 11, the ROM 12, the RAM 13, and the memory unit 14 are connected to one another via a data bus 15. The CPU 11, the ROM 12, and the RAM 13 configure a control unit 100. That is, the CPU 11 operates according to a control program 141 stored in the ROM 12 or the memory unit 14 and expanded in the RAM 13, whereby the control unit 100 executes control processing explained below.

The RAM 13 includes a commodity-information storing unit 131 and an image storing unit 132 that stores images of the customer C picked up by the image pickup unit A 221 and the image pickup unit B 222. The commodity-information storing unit 131 stores commodity information (a commodity name, a price of a commodity, and the like) corresponding to a commodity code read by the reading unit 20. This processing is referred to as commodity registration processing.

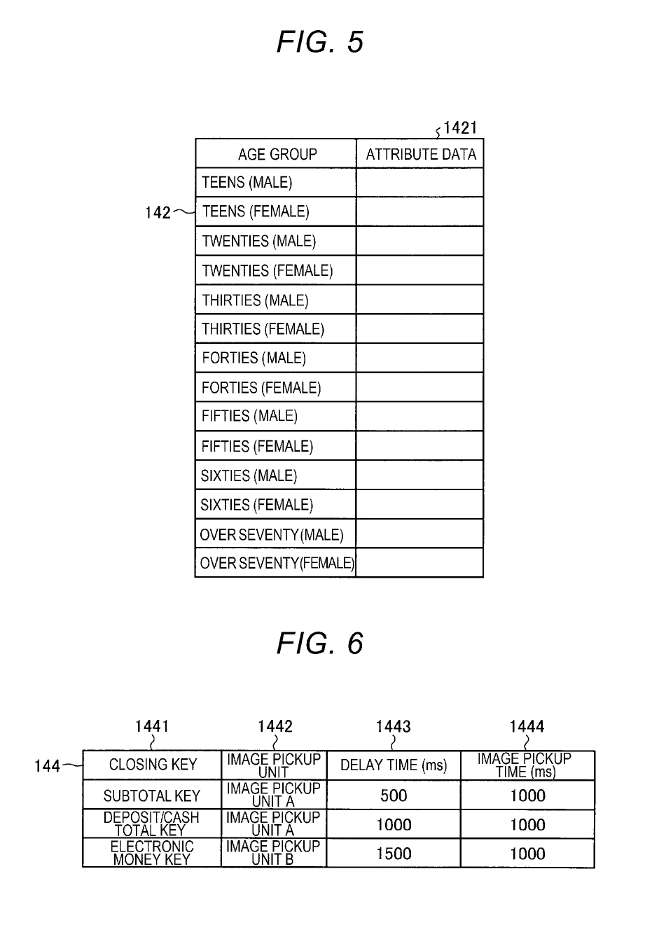

The memory unit 14 is configured by a nonvolatile memory such as a HDD (Hard Disk Drive) or a flash memory in which stored information is retained even if a power supply is turned off. The memory unit 14 stores computer programs and the like including the control program 141. The memory unit 14 stores a face master 142 (see FIG. 5), an aggregating by sex and age group section 143, and an image pickup time section 144 (see FIG. 6).

In the aggregating by sex and age group section 143, sales information and settlement information processed by the POS terminal 1 of traded commodities are aggregated and stored by sex and by age group. A tendency and a trend of purchased commodities for each age group and each sex can be analyzed on the basis of the sales information and the settlement information stored in the aggregating by sex and age group section 143. Customers who purchase commodities are aggregated by age group. For example, age group information and the like for each time of customers visiting a store are aggregated.

The operation unit 17, the store clerk display unit 18, the customer display unit 19, the reading unit 20, the printing unit 21, the image pickup unit A 221, the image pickup unit B 222, and the electronic money reader writer 23 are connected to the data bus 15 via a controller 16.

The operation unit 17 includes various keys including numeric keys and function keys. A subtotal key 171 is a key operated to declare the end of one transaction. When the subtotal key 171 is operated, end processing for one transaction is executed. A deposit and cash total key 172 is a key for declaring settlement processing for one transaction by cash. When the deposit and cash total key 172 is operated, the settlement processing by cash is executed. An electronic money key 173 is a key for declaring settlement processing for one transaction by electronic money. When the electronic money key 173 is operated, the settlement processing by electronic money is executed.

The store clerk display unit 18 is set with a display surface directed to an operator such as the store clerk CH. The store clerk display unit 18 displays information to the operator. The customer display unit 19 is set with a display surface directed to the customer C. The customer display unit 19 displays information to the customer C. Touch keys (not shown in the figure) displayed on the store clerk display unit 18 and the customer display unit 19 and touched to play a role of keys are also a part of the operation unit 17.

The reading unit 20 is configured by a CCD image sensor or the like. The reading unit 20 reads, with a CCD, a code such as a barcode or a two-dimensional code attached to a commodity and inputs the commodity code. In the embodiment, the reading unit 20 of a handy type is used. The store clerk CH holds the reading unit 20 and brings the reading unit 20 close to or into contact with a code attached to a commodity to read the code. Note that the reading unit 20 may be a scanner configured to scan emitted light with a polygon mirror or the like and receive light reflected by the code.

The printing unit 21 draws out a roll-like receipt sheet stored in the main body 2, prints commodity information, settlement information, and the like on the receipt sheet with, for example, a thermal printer including a heat transfer-type printing head, and issues the receipt sheet as a receipt.

The image pickup unit A 221 and the image pickup unit B 222 are configured by CCDs or the like. The image pickup unit A 221 and the image pickup unit B 222 pick up sequence photographs of an object such as the customer C. In the embodiment, the image pickup unit A 221 and the image pickup unit B 222 consecutively pick up, for example, ten photographs of the customer C in one second. The controller 16 receives an image pickup instruction from the control unit 100 of the POS terminal 1 and issues an image pickup instruction to the image pickup unit A 221 or the image pickup unit B 222. The image pickup unit A 221 and the image pickup unit B 222 execute image pickup according to the instruction from the controller 16.

A connection I/F (Interface) 24 electrically connected to a store server set in a store is connected to the data bus 15. The connection I/F 24 is connected to a line 25. The store server is electrically connected to all POS terminals 1 set in the store. The store server collects commodity information and settlement information from the POS terminals 1. The store server transmits the commodity information and the settlement information collected from the POS terminals 1 to a head office server (not shown in the figure) set in a head office.

The electronic money reader writer 23 is electrically connected to the POS terminal 1. When an electronic money card, in which electronic money information is stored, is placed on or brought close to the upper surface unit 231, the electronic money reader writer 23 reads, using a publicly-known NFC technique, the electronic money information stored in the electronic money card. The electronic money reader writer 23 writes electronic money information in the electronic money card using the NFC technique. The electronic money reader writer 23 reads the electronic money information from the electronic money card and writes the electronic money information in the electronic money card according to an instruction from the POS terminal 1.

FIG. 5 is a memory map showing the face master 142 of the memory unit 14. In FIG. 5, the face master 142 includes, for each sex and each age group of teens (male) to over seventy (female), attribute data sections 1421 in which attribute data including features of respective sexes and age groups. The attribute data sections 1421 store attribute data that can specify the age groups and the sexes.

The attribute data is data of parts and features for each age group and each sex in which human faces are classified according to the parts and the features. The attribute data refers to data representing features of parts such as eyes, noses, mouths, ears, and chins of people and transformed features of faces such as smiling faces, serious faces, closed eyes, and opened eyes. The attribute data stored for each age group and each sex is stored as features of the age group different from the other age groups. For example, in the attribute data section 1421 of teens (male), data of eyes, noses, mouths, and ears indicating features of teens males and data of smiling faces and serious faces indicating features of teens males are stored. The attribute data by sex and by age group is data representing the age group most created on the basis of a large number of statistical data.

The image pickup time section 144, in which a relation between operated keys and image pickup times is stored, stored in the memory unit 14 is explained with reference to FIG. 6. In FIG. 6, the image pickup time section 144 includes a key section 1441, an image pickup section 1442, a delay time section 1443, and an image pickup time section 1444.

In the key section 1441, keys to be operated are stored. The keys stored in the key section 1441 are desirably closing keys that trigger closing of a transaction. This is because, since the customer C pays attention to a total amount, an amount of change, an operation target, and the like displayed on the customer display unit 19 immediately after the closing keys are operated, the customer C substantially directly faces the customer display unit 19 and the electronic money reader writer 23 and the image pickup unit A 221 or the image pickup unit B 222 can easily pick up an image of the customer C substantially directly facing the image pickup unit. In the embodiment, in the key section 1441, three kinds of closing keys, i.e., the subtotal key 171, the deposit and cash total key 172, and the electronic money key 173 are used as triggers. Note that keys stored in the key section 1441 may be other closing keys or may be keys other than the closing keys. For example, the keys only have to be keys, immediately after operation of which the customer C tends to be in front of the image pickup unit. The keys are displayed on the customer display unit 19 and operated by the customer C by himself or herself. The keys are, for example, a key (not shown in the figure) for causing the customer C to declare the age of the customer C and a key (not shown in the figure) for causing the customer C to select presence or absence of a receipt.

In the image pickup section 1442, the image pickup units driven when the keys are operated are stored. In the embodiment, when the subtotal key 171 is operated, the image pickup unit A 221 picks up an image of the customer C. When the deposit and cash total key 172 is operated, the image pickup unit A 221 picks up an image of the customer C. When the electronic money key 173 is operated, the image pickup unit B 222 picks up an image of the customer C.

In the delay time section 1443, delay times to the start of image pickup of the customer C from operation of the keys are stored. The delay times are provided because fixed times are required for the customer C to be directly in front of the image pickup units after the closing keys are operated. In the embodiment, when the subtotal key 171 is operated, the delay time to the start of the image pickup is 500 ms. When the deposit and cash total key 172 is operated, the delay time to the start of the image pickup is 1000 ms. When the electronic money key 173 is operated, the delay time to the start of the image pickup is 1500 ms.

In the image pickup time section 1444, image pickup times from the start to the end of the image pickup are stored. In the embodiment, when the subtotal key 171 is operated, the image pickup unit A 221 executes image pickup for 1000 ms. When the deposit and cash total key 172 is operated, the image pickup unit A221 executes image pickup for 1000 ms. When the electronic money key 173 is operated, the image pickup unit B 222 executes image pickup for 1000 ms.

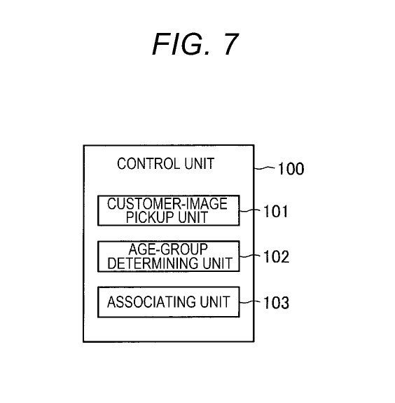

Control processing of the POS terminal 1 is explained with reference to FIGS. 7 to 13. FIG. 7 is a functional block diagram showing a functional configuration of the POS terminal. According to various computer programs including the control program 141 stored in the ROM 12 and the memory unit 14, the control unit 100 causes a customer-image pickup unit 101, an age-group determining unit 102, and an associating unit 103 to function.

The customer-image pickup unit 101 has a function of picking up, according to operation of a key, using an image pickup unit, a face image of a customer substantially directly facing the image pickup unit.

The age-group determining unit 102 has a function of comparing the picked-up face image and face image data indicating features by age group stored in advance and determining an age group of the customer.

The associating unit 103 has a function of associating the determined age group with commodity information of a commodity traded according to operation of a key.

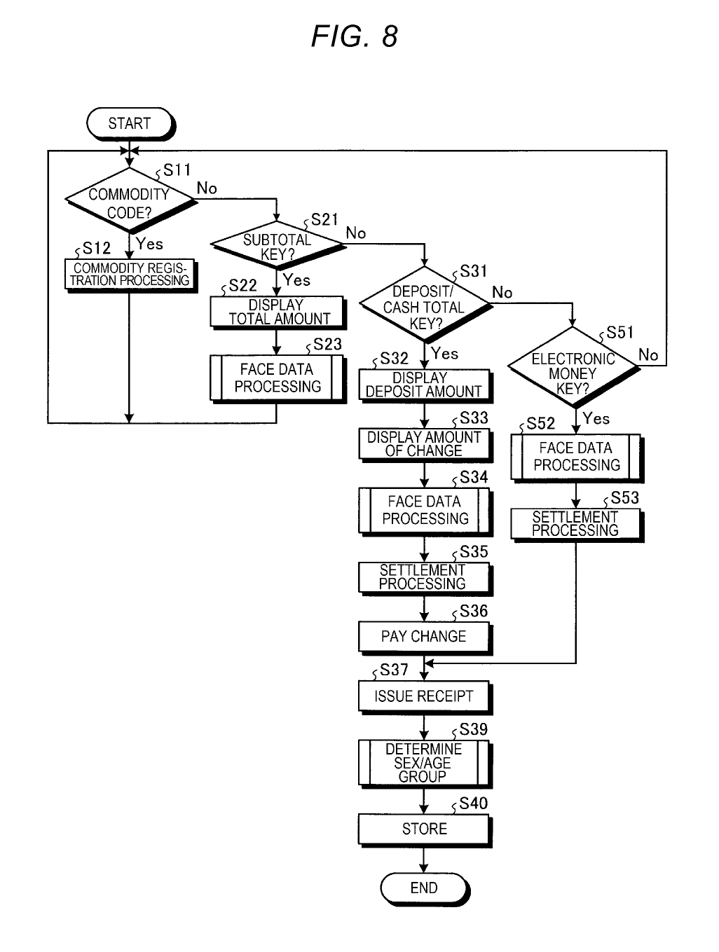

FIGS. 8 to 12 are flowcharts for explaining a flow of the control processing of the POS terminal. First, in FIG. 8, the control unit 100 determines whether a code attached to a commodity is read by the reading unit 20 and the commodity code is input (Act S11). If the control unit 100 determines that the commodity code is read (Yes in Act S11), the control unit 100 executes commodity registration processing for reading out, from a commodity master (not shown in the figure) stored in the memory unit 14 in association with the input commodity code, commodity information (a commodity name, a price of a commodity, etc.) corresponding to the commodity code and storing the commodity information in the commodity-information storing unit 131 (Act S12). Then, the control unit 100 returns to Act S11 and stays on standby.

If the control unit 100 determines that the commodity code is not input (No in Act S11), the control unit 100 determines whether the subtotal key 171 disposed in the operation unit 17 is operated (Act S21). If the control unit 100 determines that the subtotal key 171 is operated (Yes in Act S21), the control unit 100 calculates a total amount of the transaction on the basis of the commodity information stored in the commodity-information storing unit 131 and displays the total amount on the store clerk display unit 18 and the customer display unit 19 (Act S22).

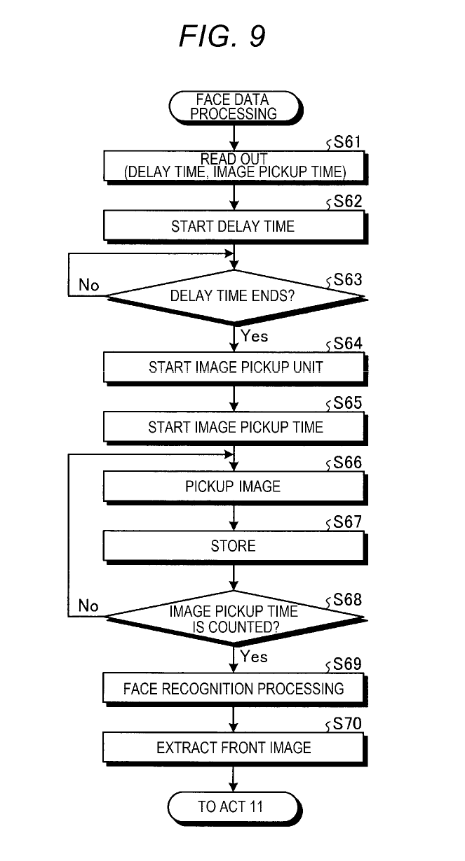

The control unit 100 executes face data processing (acquisition of face data) shown in FIG. 9 (Act S23). In FIG. 9, since the subtotal key 171 is operated, the control unit 100 reads out the delay time (500 ms) and the image pickup time (1000 ms) corresponding to the subtotal key 171 of the image pickup time section 144 from the delay time section 1443 and the image pickup time section 1444 and sets the delay time and the image pickup time in a timer (not shown in the figure) (Act S61).

Subsequently, the control unit 100 causes the timer to start the delay time (Act S62). The control unit 100 determines on the basis of counting of the timer whether the delay time elapses (Act S63). The control unit 100 stays on standby until the control unit 100 determines that the delay time elapses (No in Act S63). If the control unit 100 determines that the delay time elapses, the control unit 100 starts the image pickup unit A 221 according to the information concerning the image pickup unit stored in the image pickup section 1422 of the image pickup time section 144 (Act S64).

The control unit 100 starts the timer at the image pickup time set in Act S61 (Act S65). The control unit 100 (the image pickup unit 101) transmits, to the controller 16, an instruction for starting the image pickup unit A 221 and picking up an image of the customer C (Act S66). The instructed controller 16 controls the image pickup unit A 221 and picks up an image of the customer C.

Subsequently, the control unit 100 stores the picked-up image of the customer C in the image storing unit 132 (Act S67). The control unit 100 determines whether the timer started in Act S65 counts the set image pickup time (Act S68). If the control unit 100 determines that the timer does not count the image pickup time (No in Act S68), the control unit 100 returns to Act S66 and transmits the next image pickup instruction. In the embodiment, an interval until the next image pickup instruction is set to 100 ms. Since the image pickup time is 1000 ms, ten images are picked up until the set image pickup time is counted. Ten substantially consecutive picked-up images are stored in the image storing unit 132. The image storing unit 132 stores the series of ten consecutive images all together.

If the control unit 100 determines that the set image pickup time is counted (Yes in Act S68), the control unit 100 executes face recognition processing for each of the ten images (Act S69). The face recognition processing is processing for identifying a face from a picked-up image using a publicly-known face recognition technique. The control unit 100 compares areas of identified faces concerning the ten images and extracts five front images having large areas of the face from the ten images (Act S70). The front images are images in which the customer C more substantially directly faces the image pickup unit A 221. Attribute data characteristically indicating sex and age groups is easily extracted from the front images. The control unit 100 distinguishes the extracted five images from the other images and stores the images in the image storing unit 132. In this way, the control unit 100 acquires face data.

Referring back to FIG. 8, after executing the processing in Act S23, the control unit 100 returns to Act S11 and stays on standby. On the other hand, if the control unit 100 determines in Act S21 that the subtotal key 171 is not operated (No in Act S21), the control unit 100 determines whether the deposit and cash total key 172 is operated (Act S31). If the control unit 100 determines that the deposit and cash total key 172 is operated (Yes in Act S31), the control unit 100 displays a deposit amount handed from the customer C and input from the operation unit 17 on the store clerk display unit 18 and the customer display unit 19 (Act S32). The control unit 100 calculates an amount of change from the total amount and the deposit amount and displays the amount of change on the store clerk display unit 18 and the customer display unit 19 (Act S33). The control unit 100 executes the face data processing shown in FIG. 9 (Act S34).

Note that, in the case of Act S34, since the deposit and cash total key 172 is operated, the control unit 100 reads out the delay time (1000 ms) and the image pickup time (1000 ms) corresponding to the deposit and cash total key 172 of the image pickup time section 144 from the delay time section 1443 and the image pickup time section 1444 and sets the delay time and the image pickup time in the timer (not shown in the figure) (Act S61). The other processing in Act S34 is the same as the processing in Act S23. Therefore, explanation of the other processing is omitted.

Subsequently, the control unit 100 executes settlement processing on the basis of the commodity information, the total amount, the deposit amount, the amount of change, and the like stored in the commodity-information storing unit 131 (Act S35). The control unit 100 transmits an instruction for payment of change and change amount information to a change machine (not shown in the figure) via the connection I/F 24 (Act S36). The change machine receives the change amount information and pays change of the amount. The control unit 100 instructs the printing unit 21 to print the commodity information and settlement information (Act S37).

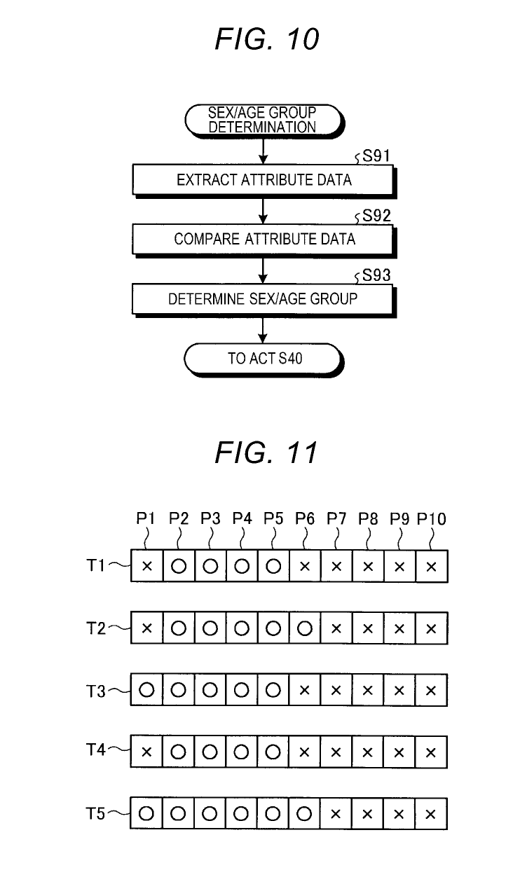

Subsequently, the control unit 100 (the age-group determining unit 102) determines, on the basis of the face images of the customer C stored in the image storing unit 132, sex and an age group of the customer C as shown in FIG. 10 (Act S39). In FIG. 10, first, the control unit 100 extracts attribute data from the front images of the face images of the customer C stored in the image storing unit 132 (Act S91). The control unit 100 compares the extracted attribute data with the attribute data stored in the attribute data section 1421 of the face master 142 (Act S92). In this case, the control unit 100 compares parts of the extracted attribute data with parts of the stored attribute data. The control unit 100 determines sex and an age group in which attribute data closest to the extracted attribute data is stored (Act S93). Specifically, the control unit 100 determines sex and an age group including a large number of closest attribute data as a result of the comparison of each of the parts. The control unit 100 (the associating unit 103) stores the determined sex and an age group in a pertinent place of the aggregating by sex and age group section 143 as sex and an age group of the customer C (Act S40). The control unit 100 stores the commodity purchased by the customer C in association with the determined sex and age group. Note that the control unit 100 may store face image data of the entire face rather than the attribute data in the face master 142 and compare the face image data with a picked-up face image of the entire face in face units.

Referring back to FIG. 8, if the control unit 100 determines in Act S31 that the deposit and cash total key 172 is not operated (No in Act S31), the control unit 100 determines whether the electronic money key 173 is operated (Act S51). If the control unit 100 determines that the electronic money key 173 is operated (Yes in Act S51), the control unit 100 executes the face data processing shown in FIG. 9 (Act S52).

Note that, in the case of Act S52, since the electronic money key 173 is operated, the control unit 100 reads out the delay time (1500 ms) and the image pickup time (1000 ms) corresponding to the electronic money key 173 of the image pickup time section 144 from the delay time section 1443 and the image pickup time section 1444 and sets the delay time and the image pickup time in the timer (not shown in the figure) (Act S61). Since the electronic money key 173 is operated, the control unit 100 drives the image pickup unit B 222 (Act S64) and picks up an image of the customer C. The other processing in Act S52 is the same as the processing in Act S23. Therefore, explanation of the processing is omitted.

Subsequently, the control unit 100 executes settlement processing on the basis of the commodity information, the total amount, the deposit amount, the amount of change, and the like stored in the commodity-information storing unit 131 (Act S53). The control unit 100 executes the processing in Act S37 and subsequent acts. If the control unit 100 determines in Act S51 that the electronic money key 173 is not operated (No in Act S51), the control unit 100 returns to Act S11 and stays on standby.

As explained above, in the embodiment, the image pickup unit A 221 or the image pickup unit B 222 picks up an image of the customer C according to the operation of the closing key. Sex and an age group are determined on the basis of the image. Therefore, variation is small compared with when the store clerk CH estimates sex and an age group. It is possible to always accurately determine sex and an age group under the same standard.

Note that, in the embodiment, the delay time and the image pickup time are adjusted by determining whether the front images are picked up at proper times with respect to the set image pickup time. For example, FIG. 11 shows picked-up images stored in the image storing unit 132. T1 to T5 respectively indicate collections of picked-up images. Images P1 to P10 indicate ten images collected as one picked-up image. In the figure, images marked by circles are images determined as front images and images marked by X are images not determined as the front images.

In the case of the example shown in FIG. 11, in the collection of T1, it is determined that face areas are large in the image P2 to P5. Similarly, it is determined that, in T2, face areas are large in P2 to P6, in T3, face areas are large in P1 to P5, in T4, face areas are large in P2 to P5, and, in T5, face areas are large in P1 to P6. That is, in the example shown in FIG. 11, it is determined that there are many front images in images picked up in the former half among the images P1 to P10. That is, it is determined that the delay time stored in the delay time section 1443 is long as a whole. Therefore, by setting the delay time stored in the delay time section 1443 shorter in view of this information, it is possible to pickup, at appropriate timings, images in which face areas are large.

Conversely, if it is determined that there are many front images in the latter half portion among the images P1 to P10, by setting the delay time short, it is possible to pick up, at appropriate timings, images in which face areas are large. In this case, the image pickup time may be set longer. Note that the adjustment of the delay time and the image pickup time may be performed for each of the closing keys. The control unit 100 may determine a time period in which there are many front images and automatically perform the adjustment of the delay time and the image pickup time.

While the embodiments have been explained above, these embodiments have been presented as examples and are not intended to limit the scope of the invention. These embodiments can be carried out in other various forms. Various omissions, substitutions, changes, and combinations can be made in a range not departing from the spirit of the invention. These embodiments and modifications thereof are included in the scope and the gist of the invention and included in the inventions described in claims and a scope of equivalents of the inventions.

For example, in the embodiment, the age groups are divided at intervals of ten years. However, the age groups maybe divided in any units. The determination for each sex is not always necessary.

In the embodiment, the images of the customer C are picked up by the two image pickup units. However, the number of the image pickup units is not limited as long as one or more image pickup units are provided.

Note that the computer program executed by the commodity sales data processing apparatus in the embodiment is provided while being recorded in a computer-readable recording medium such as a CR-ROM, a flexible disk (FD), a CD-R, or a DVD (Digital Versatile Disk) in a file of an installable form or an executable form.

The computer program executed by the commodity sales data processing apparatus in the embodiment may be stored on a computer connected to a network such as the Internet and provided by being downloaded through the network. The computer program executed by the commodity sales data processing apparatus in the embodiment may be provided or distributed through a network such as the Internet.

The computer program executed by the commodity sales data processing apparatus in the embodiment may be incorporated in a ROM or the like in advance and provided.

What is claimed is:

1. A commodity sales data processing apparatus comprising:
a key for declaring execution of processing for causing, in a commodity transaction, a customer to make a motion for substantially directly facing an image pickup unit provided in a predetermined position;
a customer-image pickup unit configured to pick up, according to operation of the key, using the image pickup unit, a face image of the customer substantially directly facing the image pickup unit;
an age-group determining unit configured to compare the picked-up face image and face image data indicating features by age group stored in advance and determine an age group of the customer; and
an associating unit configured to associate, according to the operation of the key, the determined age group with commodity information of a commodity traded in the commodity transaction.

2. The apparatus according to claim 1, wherein
the customer-image pickup unit picks up a plurality of the face images within an image pickup time set in advance, and
the age-group determining unit extracts, from the picked-up plurality of face images, a front image in which the customer substantially directly faces the image pickup unit, compares the extracted front image with a front image for each age group included in face image data indicating features by the age groups, and determines the age group.

3. The apparatus according to claim 1, wherein the customer-image pickup unit executes the image pickup by the image pickup unit after a delay time set in advance elapses from the operation of the key.

4. The apparatus according to claim 2, wherein the customer-image pickup unit executes the image pickup by the image pickup unit after a delay time set in advance elapses from the operation of the key.

5. The apparatus according to claim 1, wherein the key is a plurality of keys operated in the commodity transaction, and
the customer-image pickup unit picks up, according to an operation corresponding to processing executed in response to operation of one key among the plurality of keys, the face image using a singularity of the image pickup unit provided in a position substantially directly facing the customer.

6. The apparatus according to claim 3, further comprising an adjusting unit configured to adjust at least one of the delay time and the image pickup time such that image pickup timing of the image pickup unit by the customer-image pickup unit is appropriate.

7. A method for causing a computer including a key for declaring execution of processing for causing, in a commodity transaction, a customer to make a motion for substantially directly facing an image pickup unit provided in a predetermined position to function as:
a customer-image pickup unit configured to pick up, according to operation of the key, using the image pickup unit, a face image of the customer substantially directly facing the image pickup unit;
an age-group determining unit configured to compare the picked-up face image and face image data indicating features by age group stored in advance and determine an age group of the customer; and
an associating unit configured to associate, according to the operation of the key, the determined age group with commodity information of a commodity traded in the commodity transaction.
